(19) United States
(12) Patent Application Publication
(10) Pub. No.: US 2025/0088938 A1
(43) Pub. Date: Mar. 13, 2025

(54) Methods And Apparatus For Enhanced User Equipment Route Selection Policy With Green Incentives For Environmental Conservation

(71) Applicant: MediaTek Inc., Hsinchu City (TW)

(72) Inventors: Chien-Sheng Yang, Hsinchu City (TW); Yuan-Chieh Lin, Hsinchu City (TW); Yu-Hsin Lin, Hsinchu City (TW); Chia-Lin Lai, Hsinchu City (TW); I-Kang Fu, Hsinchu City (TW)

(21) Appl. No.: 18/773,576

(22) Filed: Jul. 16, 2024

Related U.S. Application Data
(60) Provisional application No. 63/581,310, filed on Sep. 8, 2023.
(60) Provisional application No. 63/581,311, filed on Sep. 8, 2023.

(51) Int. Cl. H04W 40/04

(52) U.S. Cl. CPC H04W 40/04

(57) ABSTRACT

Various solutions for enhanced user equipment (UE) route selection policy (URSP) with green incentives for environmental conservation are described. An apparatus may receive information of an application associated with one or more eco-friendly requirements. Then, the apparatus may select a URSP rule from a list of URSP rules, and the selected URSP rule includes one or more descriptors matching the one or more eco-friendly requirements. Also, the apparatus may determine a data session for routing traffic of the application between the apparatus and a wireless network based on one or more parameters included in a route selection descriptor (RSD) of the selected URSP rule.

### CROSS REFERENCE TO RELATED PATENT APPLICATION(S)

The present disclosure is part of a non-provisional application claiming the priority benefit of U.S. patent application Ser. No. 63/581,310, filed 8 Sep. 2023, and U.S. patent application Ser. No. 63/581,311, filed 8 Sep. 2023. The contents of aforementioned applications are herein incorporated by reference in their entirety.

### TECHNICAL FIELD

The present disclosure is generally related to mobile communications and, more particularly, to enhanced user equipment (UE) route selection policy (URSP) with green incentives for environmental conservation.

### BACKGROUND

Unless otherwise indicated herein, approaches described in this section are not prior art to the claims listed below and are not admitted as prior art by inclusion in this section.

To encourage renewable electricity (or called “green” electricity) adoption, emerging carbon tax/fee (e.g., 10+ United States dollars (USD) per ton of carbon dioxide (CO2)) regulation worldwide is being put in place to raise the cost of traditional electricity (or called “gray” electricity). In response to this trend, leading companies are now pushing their supply chains to neutralize or mitigate carbon footprint in manufacturing and transportation, and new businesses on carbon credit and renewable energy certificate trading are growing rapidly.

It is observed that the Information/Communications Technology (ICT) industry is one of the biggest consumers of electricity. The ICT industry's estimated consumption of worldwide electricity stands at 2-3% today, and it is predicted to increase to around 8-21% by the year of 2030. Hence, it is important for the technology industry to consider not only how to reduce its electricity consumption, but also the transition to cleaner sources of energy. Nevertheless, quantifying and subsequently reducing the consumption of electricity is no easy task, as there are many contributors for a web-based mobile application, including (i) electricity usage of the mobile device running the application; (ii) the infrastructure that carries the application message over the radio link to a cell tower; (iii) the cell tower shared by more than one carrier and the fiber connecting the tower to the Internet backbone networks, owned by various Internet service providers (ISPs); and (iv) the data center runs the application logic in a cloud platform shared by different businesses. In addition to measure the aggregated impact of each of these components to determine the total electricity usage, it is also important to derive the carbon-intensity of energy consumption, in order to determine the carbon footprint of network elements (e.g., hardware and/or software) when they are put into service. Electricity may be generated from various energy sources (e.g., gas, coal, nuclear, wind, and solar energy, etc.) with different levels of carbon emissions. In particular, due to the highly variable and unpredictable nature of renewable energy sources (e.g., wind and solar energy), carbon intensity (i.e., average carbon emissions per unit of energy consumption) of electricity grid varies considerably by time and location. As such, a challenge for carbon emissions reduction in the ICT industry is how to design a signaling framework and/or scheduling policy for applications with eco-friendly requirements in mobile communications, which accounts for temporal and spatial dimensions of energy sources.

Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and/or apparatus pertaining to enhanced URSP with green incentives for environmental conservation. It is believed that the above-described issue would be avoided or otherwise alleviated by implementing one or more of the proposed schemes described herein.

In one aspect, a method may involve an apparatus receiving information of an application associated with one or more eco-friendly requirements. The method may also involve the apparatus selecting a URSP rule from a list of URSP rules, wherein the selected URSP rule comprises one or more descriptors matching the one or more eco-friendly requirements. The method may further involve the apparatus determining a data session for routing traffic of the application between the apparatus and a wireless network based on one or more parameters included in a route selection descriptor (RSD) of the selected URSP rule.

In one aspect, an apparatus may comprise a transceiver which, during operation, wirelessly communicates with a wireless network. The apparatus may also comprise a processor communicatively coupled to the transceiver. The processor, during operation, may perform operations comprising receiving information of an application associated with one or more eco-friendly requirements. The processor may also perform operations comprising selecting a URSP rule from a list of URSP rules, wherein the selected URSP rule comprises one or more descriptors matching the one or more eco-friendly requirements. The processor may further perform operations comprising determining a data session for routing traffic of the application between the apparatus and the wireless network based on one or more parameters included in an RSD of the selected URSP rule.

In one aspect, a method may involve a first network entity receiving network analytics related to eco-rating information from a second network entity. The method may also involve the first network entity adjusting a precedence of one or more RSDs in a URSP rule, wherein the RSDs comprise one or more relay service codes (RSCs) selected based on the eco-rating information. The method may further involve the first network entity updating one or more parameters of the URSP rule.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of the content of a traffic descriptor (TD) for an enhanced URSP rule in accordance with an implementation of the present disclosure.

FIG. 3 is a diagram depicting an example scenario of the content of an enhanced URSP rule in accordance with an implementation of the present disclosure.

FIG. 4 is a diagram depicting an example scenario of the content of an RSD for an enhanced URSP rule in accordance with an implementation of the present disclosure.

FIG. 5 is a diagram depicting an example scenario of the content of an enhanced URSP rule in accordance with an implementation of the present disclosure.

FIG. 6 is a block diagram of an example communication system in accordance with an implementation of the present disclosure.

FIG. 7 is a flowchart of an example process in accordance with an implementation of the present disclosure.

FIG. 8 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhanced URSP with green incentives for environmental conservation. According to the present disclosure, a number of possible solutions may be implemented separately or jointly. That is, although these possible solutions may be described below separately, two or more of these possible solutions may be implemented in one combination or another.

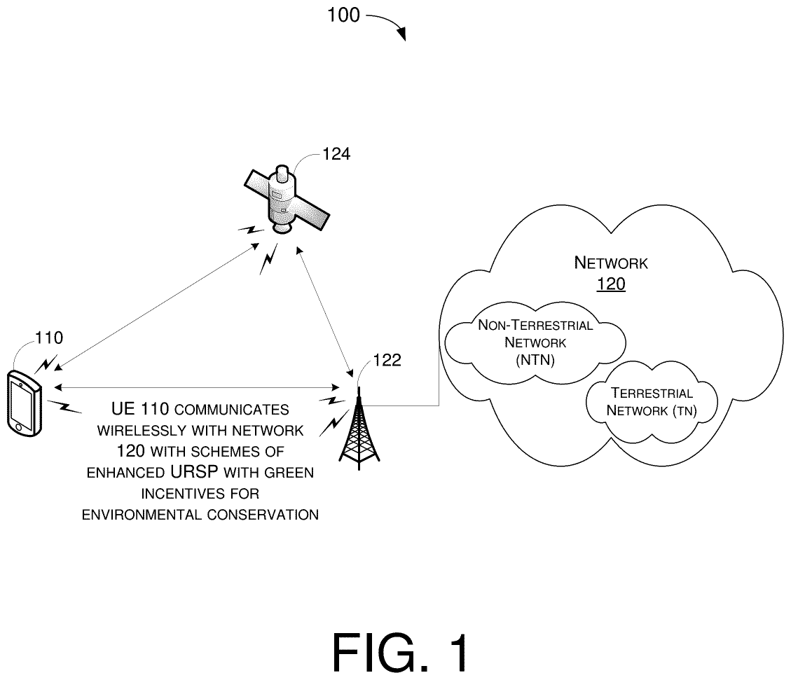

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including a non-terrestrial network (NTN) and a TN) via at least a terrestrial network node 122 (e.g., a base station (BS) such as an evolved Node-B (eNB), a Next Generation Node-B (gNB), or a transmission/reception point (TRP), or a (wireless-fidelity) access point (AP)) and/or at least a non-terrestrial network node 124 (e.g., a satellite). For example, the terrestrial network node 122 may form a TN serving cell for wireless communication with the UE 110, or the terrestrial network node 122 and/or the non-terrestrial network node 124 may form an NTN serving cell for wireless communication with the UE 110. In some implementations, the network 120 may be a 4G/5G/B5G/6G network, and the UE 110 may be a smartphone, a tablet computer, a laptop computer or a notebook computer. Alternatively, the network 120 may be an IoT/NB-IoT/IIoT network, and the UE 110 may be an IoT device such as an NB-IoT UE or an enhanced machine-type communication (eMTC) UE (e.g., a bandwidth reduced low complexity (BL) UE or a coverage enhancement (CE) UE). In the network 120, each network component, such as a radio access network (RAN) component (e.g., a cell formed by the terrestrial network node 122 and/or the non-terrestrial network node 124), and a core network (CN) component (e.g., a network slice, or a data network (name), etc.), may has a different eco-rating score. For example, some network node may use more renewable/green energy sources and thus, have a higher eco-rating score; or some network node may use more non-renewable/gray energy (e.g., on-grid power) sources and thus, have a lower eco-rating score. Additionally, the network 120 may include a core network with multiple network entities which may be implemented as software and/or hardware in one or more network nodes (e.g., computing devices/servers). For example, if the network 120 is a 5G system (5GS), the core network entities may include an access and mobility function (AMF), session management function (SMF), policy control function (PCF), unified data management (UDM), access and mobility function (AMF), and network data analytics function (NWDAF), etc. If the network 120 is a 4G system (4GS), the core network entities may include mobility management entity (MME), serving gateway (S-GW), packet data network gateway (P-GW), and home subscriber server (HSS), etc. In such communication environment, the UE 110, the network 120, the terrestrial network node 122, and/or the non-terrestrial network node 124 may implement various schemes pertaining to enhanced URSP with green incentives for environmental conservation in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Electricity/energy has a carbon intensity depending on where/when/how it is consumed and what sources it is generated from (e.g., solar power has lower carbon intensity, and fossil fuel has higher carbon intensity). In the real world, the availability of sustainable/renewable/green energy can vary significantly over time across different locations. An intensity may be referred to as a rate that has a numerator and a denominator. A rate may provide helpful information when considering how to design, develop, deploy, and operate green networks. For simplicity, in the present disclosure, the term “eco-rating” is used to accommodate both total amount and rate concepts regarding environmental impact. Specifically, eco-rating is a factor that is calculated taking environmental impact into account. For example, an eco-rating score may be the carbon intensity/efficiency/emission/footprint level (of energy/resource consumption) which can be further considered as a factor per service, per subscriber, per UE, per unit (e.g., byte) of data transmit/receive, or per network element (e.g., per BS, per CN element, or per application server, etc.). Typically, a high eco-rating score means less environmental impact or greener (e.g., a better eco-rating, or a higher carbon efficiency rating) and higher sustainability (e.g., lower carbon intensity/efficiency/emission/footprint level (of energy/resource consumption)). A low eco-rating score means more environmental impact or less green (e.g., a worse eco-rating, or a lower carbon efficiency rating) and lower sustainability (e.g., higher carbon intensity/efficiency/emission/footprint level (of energy/resource consumption)).

It should be noted that other terms representing similar or the same green (i.e., eco-friendly) concept may be used as a substitute of the term “eco-rating” in the present disclosure. For example, energy efficiency may be used as a substitute of eco-rating, where high energy efficiency means less environmental impact (i.e., high eco-rating or greener), and low energy efficiency means more environmental impact (i.e., low eco-rating or less green). Energy consumption may also be used as a substitute of eco-rating, where low energy consumption means less environmental impact (i.e., high eco-rating or greener), and high energy consumption means more environmental impact (i.e., low eco-rating or less green). Green factor may also be used as a substitute of eco-rating, where high green factor means less environmental impact (i.e., high eco-rating or greener), and low green factor means more environmental impact (i.e., low eco-rating or less green). Carbon-intelligent or carbon-aware may be used to describe an approach that intends to achieve less environmental impact (i.e., high eco-rating, or greener). Using more renewable/clean energy may also mean high eco-rating or greener.

In 5G NR, UE policies may include the URSP and the Access Network Discovery and Selection Policy (ANDSP). The UE policies may be delivered from a PCF to a UE. The PCF takes care of network policies to manage network behavior. The PCF gets the subscription information from the UDM. The PCF interfaces to both the AMF to manage the mobility context and the SMF to manage the session contexts. The PCF also plays a crucial role in providing a schema for network slicing and roaming. The PCF triggers the URSP which enables the UE to determine how a certain application should be handled in the context of an existing or new protocol data unit (PDU) session. Typically, URSP may include a list of URSP rules. The UE policies can also be pre-configured in the UE. The pre-configured policy should be applied by the UE only when the UE has not received the same type of policy from the PCF. However, in the current 5G NR framework, URSP does not take environmental impacts (e.g., represented by eco-rating) into account.

In view of the above, the present disclosure proposes a number of schemes pertaining to enhanced URSP with green incentives for environmental conservation. Under certain schemes of the present disclosure, new descriptor(s) (referred to herein as green descriptor(s)), may be introduced in the TD or the RSD of each URSP rule. Specifically, the green descriptor(s) may include an indication that a data network (e.g., represented by a data network name (DNN)), a network slice (e.g., represented by single-network slice selection assistance information (S-NSSAI)), or a data session (e.g., a PDU session) with a higher eco-rating score is preferred, and/or a threshold corresponding to an eco-rating score above or equal to which a data network, a network slice, or a data session is preferred. Accordingly, the URSP rules evaluation will take environmental impacts (e.g., represented by eco-rating) into account, thereby allowing the network resource allocation and utilization to be more eco-friendly or carbon-intelligent/aware.

For the case that green descriptors are introduced in a TD, when upper layers (e.g., application layer) request to consider eco-rating information of networks (e.g., upper layers may indicate some eco-friendly requirements including eco-rating target/threshold as preference when requesting a network connection for an application), the UE may check the green descriptors in the TD to determine whether the TD is matched against the eco-friendly requirements provided by the upper layers. If matched, an RSD of the URSP rule containing the TD is used/selected by the UE to determine the parameters of an existing data session (e.g., PDU session) or a new data session (e.g., PDU session) to be established for the application. The UE (e.g., the non-access stratum (NAS) layer) may provide information (e.g., PDU address) of the existing data session that matches the route selection to the upper layers, or may provide information (e.g., PDU address) of the successfully established new data session to the upper layers. Otherwise, if no TD of any URSP rule is matched, the UE may inform the upper layers of the failure or use the UE local configuration.

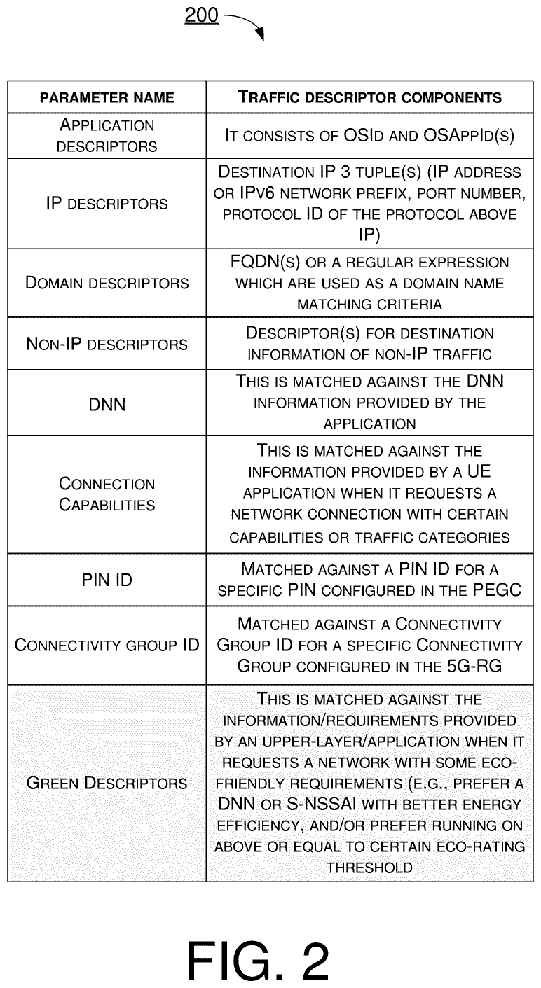

FIG. 2 illustrates an example scenario 200 of the content of a TD for an enhanced URSP rule in accordance with an implementation of the present disclosure. As shown in FIG. 2, additional green descriptors are introduced as a TD component (denoted in grey background) for each URSP rule. Specifically, the green descriptors are matched against the information/requirements provided by an upper-layer or an application requesting a network with some eco-friendly requirements (e.g., prefer a DNN or S-NSSAI with better energy efficiency, and/or prefer running on above or equal to certain eco-rating threshold).

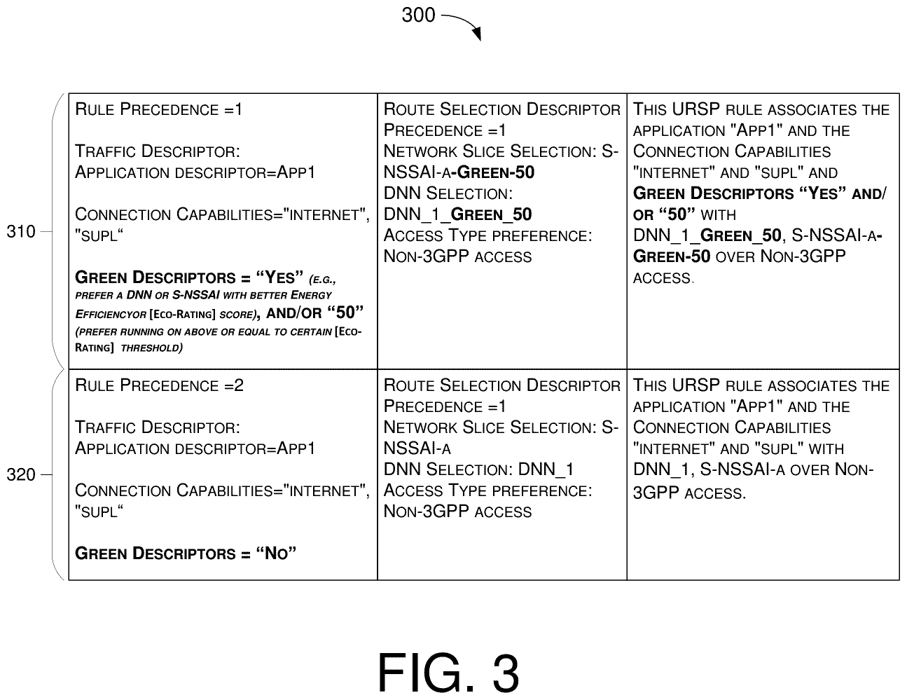

FIG. 3 illustrates an example scenario 300 of the content of an enhanced URSP rule in accordance with an implementation of the present disclosure. Depicted by 310, the first URSP rule includes a TD with green descriptors corresponding to the eco-friendly requirements of an application “App1”. Specifically, the green descriptors indicate a DNN or S-NSSAI with better energy efficiency is preferred and/or indicate an eco-rating threshold that a DNN or S-NSSAI with an eco-rating score above or equal to this threshold is preferred. In addition, the RSD of the first URSP rule indicates an S-NSSAI and a DNN corresponding to the eco-friendly requirements. That is, the first URSP rule associates the application “App1” and the Connection Capabilities “internet” and “supl” and Green Descriptors “Yes” and/or “50” with DNN_1_Green_50, S-NSSAI-a-Green-50 over non-3GPP access. As such, this enforces the following routing policy: when the “App1” requests a network connection with Connection Capability “internet” (i.e., the network connection should support Internet access) or “supl” (i.e., the network connection should support secure user plane location (SUPL) service) and Green Descriptors “Yes” and/or “50”, the UE establishes (if not already established) a PDU session with DNN_1_Green_50 and S-NSSAI-a-Green-50 over non-3GPP access, and then the UE routes the traffic of “App1” over this PDU session. Depicted by 320, the second URSP rule includes a TD with green descriptors indicating no eco-friendly requirements need to be considered, and this enforces the following routing policy: when the “App1” requests a network connection with Connection Capability “internet” or “supl”, the UE establishes (if not already established) a PDU session with DNN_1 and S-NSSAI-a over non-3GPP access, and then the UE routes the traffic of “App1” over this PDU session.

For the case that green descriptors are introduced in an RSD, when an RSD is selected/used/utilized, the UE may use the Green Descriptors in the RSD to determine the parameters (e.g., request a data session (e.g., PDU session) with better energy efficiency or eco-rating score, and/or prefer running on above or equal to certain eco-rating threshold) in a request message (e.g., PDU Session Establishment Request) to the network when establishing a data session based on the Green Descriptors in the RSD. In one example, when the network receives the parameters in the request message, the network may determine whether the parameters can be met/accepted/satisfied or not, and reply with an accept message if the parameters can be met/accepted/satisfied, or with a reject message if the parameters cannot be met/accepted/satisfied. If the UE receives a reject message, it may then evaluate next URSP rule or next RSD. In another example, the network may always accept the request message and reply with the eco-rating score of the data session to the UE, so that the UE may determine whether to use this data session based on the eco-rating score. Additionally, or optionally, the network may (regularly) update the eco-rating score of the data session via a session modification procedure to the UE, and the UE may re-evaluate URSP rules when the eco-rating score of the data session is updated. Alternatively, the UE may use the Green Descriptors in the RSD to determine the parameters (e.g., request a data session (e.g., PDU session) with better energy efficiency or eco-rating score, and/or prefer running on above or equal to certain eco-rating threshold) of an existing data session (e.g., parameters in the PDU Session Establishment Accept) to be matched against the Green Descriptors in the RSD. The UE (e.g., the NAS layer) may provide information (e.g., PDU address) of the existing data session that matches the route selection Green Descriptors to the upper layers, or may provide information (e.g., PDU address) of the successfully established new data session to the upper layers.

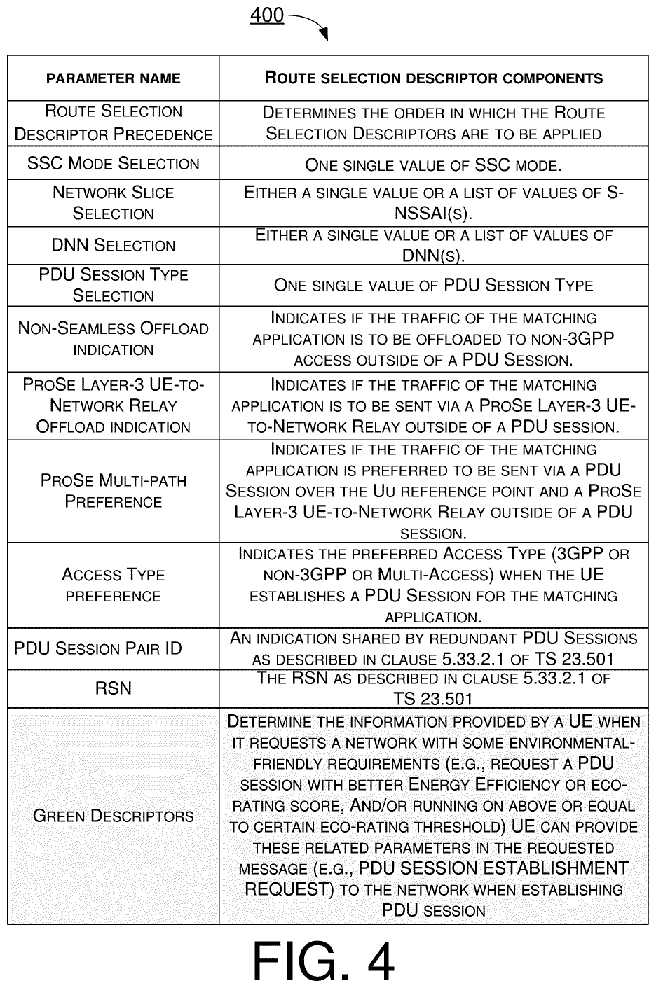

FIG. 4 illustrates an example scenario 400 of the content of an RSD for an enhanced URSP rule in accordance with an implementation of the present disclosure. As shown in FIG. 4, additional green descriptors are introduced as an RSD component (denoted in grey background) for each URSP rule. Specifically, the green descriptors may determine the information provided by a UE when it requests a network with some eco-friendly requirements (e.g., request a PDU session with better energy efficiency or eco-rating score, and/or prefer running on above or equal to certain eco-rating threshold). The UE may provide these related parameters in a request message (e.g., PDU Session Establishment Request) to the network when establishing PDU session.

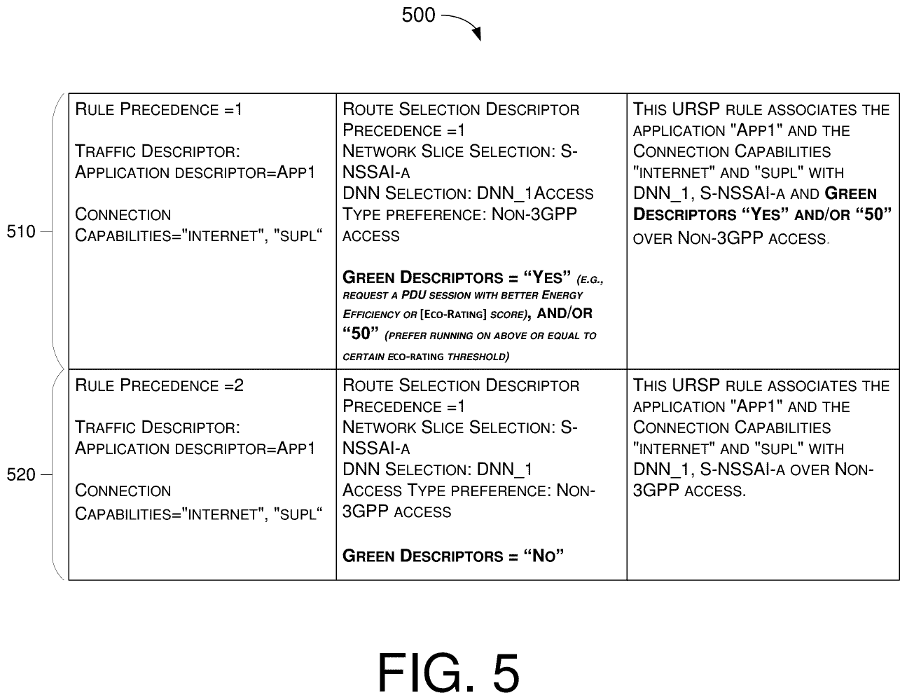

FIG. 5 illustrates an example scenario 500 of the content of an enhanced URSP rule in accordance with an implementation of the present disclosure. Depicted by 510, the first URSP rule includes an RSD with green descriptors corresponding to the eco-friendly requirements of an application “App1”. Specifically, the green descriptors indicate a DNN or S-NSSAI with better energy efficiency is preferred and/or indicate an eco-rating threshold that a DNN or S-NSSAI with an eco-rating score above or equal to this threshold is preferred. That is, the first URSP rule associates the application “App1” and the Connection Capabilities “internet” and “supl” with DNN_1, S-NSSAI-a and Green Descriptors “Yes” and/or “50” over non-3GPP access. As such, this enforces the following routing policy: when the “App1” requests a network connection with Connection Capability “internet” or “supl”, the UE establishes (if not already established) a PDU session with DNN_1 and S-NSSAI-a and Green Descriptors “Yes” and/or “50” over non-3GPP access, and then the UE routes the traffic of “App1” over this PDU session. Depicted by 520, the second URSP rule includes an RSD with green descriptors indicating no eco-friendly requirements need to be considered, and this enforces the following routing policy: when the “App1” requests a network connection with Connection Capability “internet” or “supl”, the UE establishes (if not already established) a PDU session with DNN_1 and S-NSSAI-a over non-3GPP access, and then the UE routes the traffic of “App1” over this PDU session.

Under certain schemes of the present disclosure, the PCF (or another network entity with similar functionality) may receive network analytics related to eco-rating information from the network data analytics function (NWDAF) (or another network entity with similar functionalities of collecting data from core network and providing analytics to support network automation, closed-loop operations, self-healing, experience improvement and reporting, etc.), so that it may use the eco-rating information for selecting RSC(s), adjusting RSD precedence, and updating URSP. Specifically, the PCF may select at least one of a network slice, a DNN, a data session type, a session and service continuity (SSC) mode, and an access type, as one RSC or a combination of RSCs in URSP rule for an application. The PCF may adjust the RSD precedence in URSP in terms of eco-rating information/statistics/predictions/score of the whole RSD (a combination of RSCs). The PCF may update the URSP on one or several of Network Slice Selection Policy, DNN Selection Policy, (PDU) Session Type Policy, SSC Mode Selection Policy, Access Type preference and the priority of each RSD. Additionally, or optionally, the PCF may subscribe to notifications of the network analytics related to eco-rating information from NWDAF.

### Illustrative Implementations

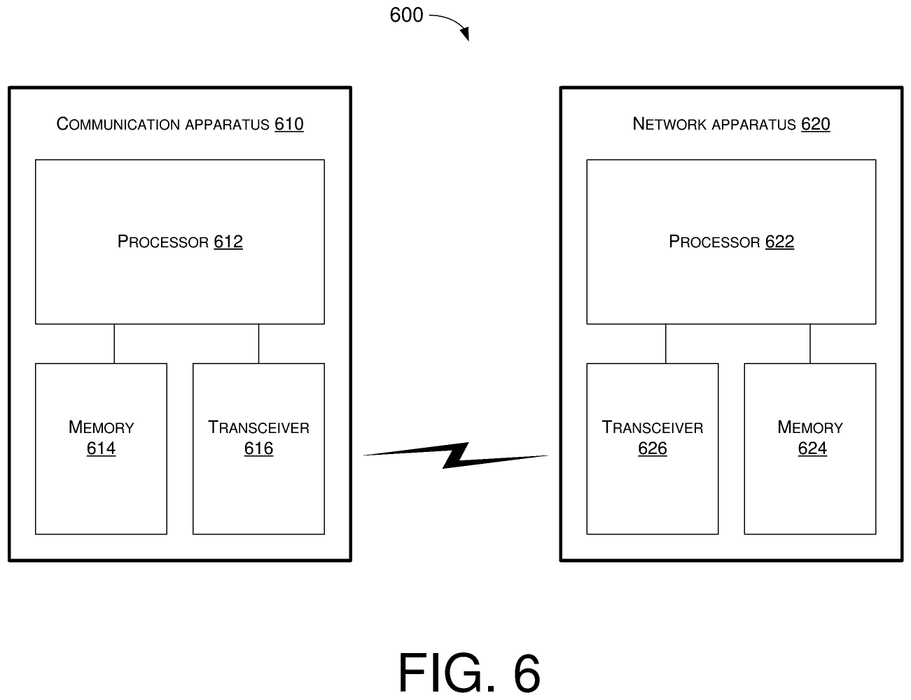

FIG. 6 illustrates an example communication system 600 having an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to enhanced URSP with green incentives for environmental conservation, including scenarios/schemes described above as well as processes 700 and 800 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 610 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed schemes of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of an electronic apparatus, which may be a network node such as a satellite, a BS, a small cell, a router or a gateway of an IoT network. For instance, network apparatus 620 may be implemented in a satellite or an eNB/gNB/TRP in a 4G/5G/B5G/6G, NR, IoT, NB-IoT or IIoT network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks, including enhanced URSP evaluation with green incentives for environmental conservation, in a device (e.g., as represented by communication apparatus 610) and a network node (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, transceiver 616 may be capable of wirelessly communicating with different types of UEs and/or wireless networks of different radio access technologies (RATs). In some implementations, transceiver 616 may be equipped with a plurality of antenna ports (not shown) such as, for example, four antenna ports.

That is, transceiver 616 may be equipped with multiple transmit antennas and multiple receive antennas for multiple-input multiple-output (MIMO) wireless communications. In some implementations, network apparatus 620 may also include a transceiver 626 coupled to processor 622. Transceiver 626 may include a transceiver capable of wirelessly transmitting and receiving data. In some implementations, transceiver 626 may be capable of wirelessly communicating with different types of UEs of different RATs. In some implementations, transceiver 626 may be equipped with a plurality of antenna ports (not shown) such as, for example, four antenna ports. That is, transceiver 626 may be equipped with multiple transmit antennas and multiple receive antennas for MIMO wireless communications.

In some implementations, communication apparatus 610 may further include a memory 614 coupled to processor 612 and capable of being accessed by processor 612 and storing data (e.g., URSP rules) therein. In some implementations, network apparatus 620 may further include a memory 624 coupled to processor 622 and capable of being accessed by processor 622 and storing data (e.g., URSP rules) therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 610 and network apparatus 620 may be a communication entity capable of communicating with each other using various proposed schemes in accordance with the present disclosure. For illustrative purposes and without limitation, a description of capabilities of communication apparatus 610, as a UE, and network apparatus 620, as a RAN/CN network node (e.g., satellite/BS, or AMF/UPF), is provided below with processes 700 and 800.

### Illustrative Processes

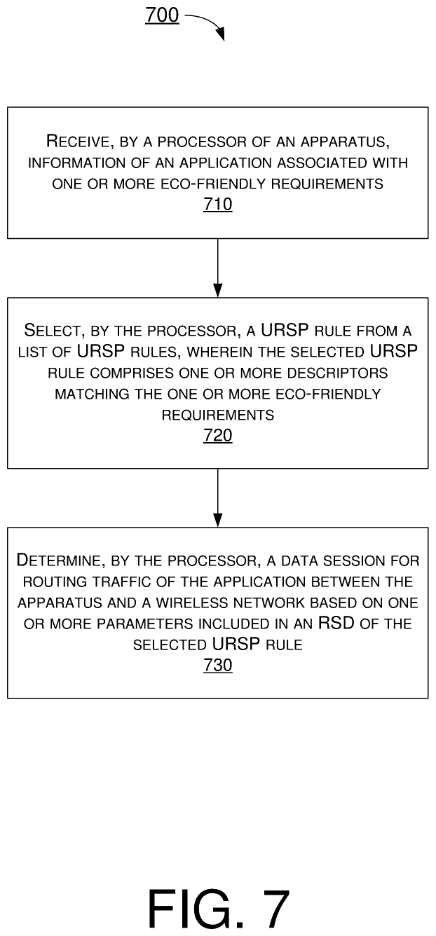

FIG. 7 illustrates an example process 700 under schemes in accordance with an implementation of the present disclosure. Process 700 may represent an aspect of implementing various proposed designs, concepts, schemes, systems and methods described above, whether partially or entirely, including those described above. More specifically, process 700 may represent an aspect of the proposed concepts and schemes pertaining to enhanced URSP with green incentives for environmental conservation. Process 700 may include one or more operations, actions, or functions as illustrated by one or more of blocks 710, 720, and 730. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively, in a different order. Furthermore, one or more of the blocks/sub-blocks of process 700 may be executed iteratively. Process 700 may be implemented by or in communication apparatus 610 and communication apparatus 620 as well as any variations thereof. Solely for illustrative purposes and without limiting the scope, process 700 is described below in the context of communication apparatus 610 as a UE and network apparatus 620 as a network node (e.g., AMF/UPF). Process 700 may begin at block 710.

At 710, process 700 may involve processor 612 of communication apparatus 610, implemented in or as a UE, receiving information of an application associated with one or more eco-friendly requirements. Process 700 may proceed from 710 to 720.

At 720, process 700 may involve processor 612 selecting a URSP rule from a list of URSP rules, wherein the selected URSP rule comprises one or more descriptors matching the one or more eco-friendly requirements. Process 700 may proceed from 720 to 730.

At 730, process 700 may involve processor 612 determining a data session for routing traffic of the application between communication apparatus 610 and a wireless network based on one or more parameters included in an RSD of the selected URSP rule.

In some implementations, the one or more descriptors may be included in a TD of the selected URSP rule, or included in the RSD of the selected URSP rule.

In some implementations, the one or more descriptors may include at least one of the following: an indication that a data network, a network slice, or a data session with a higher eco-rating score is preferred; and a threshold corresponding to an eco-rating score above or equal to which a data network, a network slice, or a data session is preferred.

In some implementations, the eco-rating score may indicate one of the following: an energy efficiency level, an energy consumption level, a carbon intensity, carbon efficiency, carbon emission, or carbon footprint level, and a renewable or clean energy level.

In some implementations, the data session may be an existing data session that matches the RSD of the selected URSP rule.

In some implementations, process 700 may further involve processor 612 transmitting, via transceiver 616, a data session establishment request message to network apparatus 620 based on the RSD of the selected URSP rule. Additionally, process 700 may involve processor 612 receiving, via transceiver 616, a data session establishment accept message from network apparatus 620, wherein the data session establishment accept message comprises information of the data session.

In some implementations, the data session establishment accept message may include an eco-rating score associated with the data session. Additionally, process 700 may further involve processor 612 determining whether to use the data session based on the eco-rating score in the data session establishment accept message.

In some implementations, process 700 may further involve processor 612 receiving, via transceiver 616, a data session modification request message from network apparatus 620, wherein the data session modification request message indicates an updated eco-rating score associated with the data session. Additionally, process 700 may involve processor 612 reselecting a URSP rule from the list of URSP rules, wherein the reselected URSP rule comprises one or more descriptors matching the one or more eco-friendly requirements.

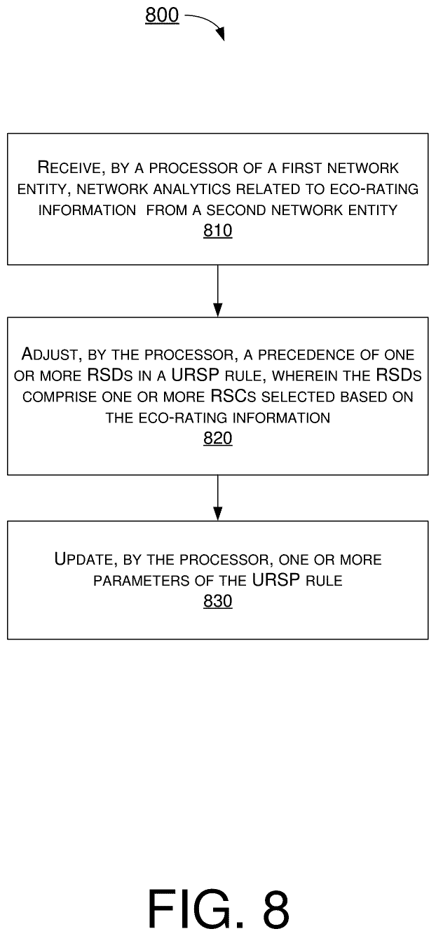

FIG. 8 illustrates an example process 800 under schemes in accordance with an implementation of the present disclosure. Process 800 may represent an aspect of implementing various proposed designs, concepts, schemes, systems and methods described above, whether partially or entirely, including those described above. More specifically, process 800 may represent an aspect of the proposed concepts and schemes pertaining to enhanced URSP with green incentives for environmental conservation. Process 800 may include one or more operations, actions, or functions as illustrated by one or more of blocks 810 to 830. Although illustrated as discrete blocks, various blocks of process 800 may be divided into additional blocks, combined into fewer blocks, or eliminated, depending on the desired implementation. Moreover, the blocks/sub-blocks of process 800 may be executed in the order shown in FIG. 8 or, alternatively in a different order. Furthermore, one or more of the blocks/sub-blocks of process 800 may be executed iteratively. Process 800 may be implemented by or in network apparatus 620 and another network apparatus as well as any variations thereof. Solely for illustrative purposes and without limiting the scope, process 800 is described below in the context of network apparatus 620 as a first network entity (e.g., UPF), another network apparatus (not shown) as a second network entity (e.g., NWDAF), and communication apparatus 610 as a UE. Process 800 may begin at block 810.

At 810, process 800 may involve processor 622 of network apparatus 620, implemented in or as a first network entity, receiving, via transceiver 626, network analytics related to eco-rating information from the second network entity. Process 800 may proceed from 810 to 820.

At 820, process 800 may involve processor 622 adjusting a precedence of one or more RSDs in a URSP rule, wherein the RSDs comprise one or more RSCs selected based on the eco-rating information. Process 800 may proceed from 820 to 830.

At 830, process 800 may involve processor 622 updating one or more parameters of the URSP rule.

In some implementations, process 800 may further involve processor 622 subscribing to notifications of the network analytics related to eco-rating information from the second network entity.

In some implementations, the one or more RSCs comprise at least one of the following: a network slice, a DNN, a data session (e.g., PDU session) type, an SSC mode, and an access type (e.g., indicating 3GPP access or non-3GPP access).

In some implementations, the eco-rating information may include an eco-rating score indicating one of the following: an energy efficiency level, an energy consumption level, a carbon intensity, carbon efficiency, carbon emission, or carbon footprint level, and a renewable or clean energy level.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, information of an application associated with one or more eco-friendly requirements;
selecting, by the processor, a user equipment (UE) route selection policy (URSP) rule from a list of URSP rules, wherein the selected URSP rule comprises one or more descriptors matching the one or more eco-friendly requirements; and
determining, by the processor, a data session for routing traffic of the application between the apparatus and a wireless network based on one or more parameters included in a route selection descriptor (RSD) of the selected URSP rule.

2. The method of claim 1, wherein the one or more descriptors are included in a traffic descriptor (TD) of the selected URSP rule, or included in the RSD of the selected URSP rule.

3. The method of claim 1, wherein the one or more descriptors comprise at least one of the following:
an indication that a data network, a network slice, or a data session with a higher eco-rating score is preferred; and
a threshold corresponding to an eco-rating score above or equal to which a data network, a network slice, or a data session is preferred.

4. The method of claim 3, wherein the eco-rating score indicates one of the following:
an energy efficiency level;
an energy consumption level;
a carbon intensity, carbon efficiency, carbon emission, or carbon footprint level; and
a renewable or clean energy level.

5. The method of claim 1, wherein the data session is an existing data session that matches the RSD of the selected URSP rule.

6. The method of claim 1, further comprising:
transmitting, by the processor, a data session establishment request message to a network node of the wireless network based on the RSD of the selected URSP rule; and
receiving, by the processor, a data session establishment accept message from the network node, wherein the data session establishment accept message comprises information of the data session.

7. The method of claim 6, wherein the data session establishment accept message comprises an eco-rating score associated with the data session, and the method further comprises:
determining, by the processor, whether to use the data session based on the eco-rating score in the data session establishment accept message.

8. The method of claim 7, further comprising:
receiving, by the processor, a data session modification request message from the network node, wherein the data session modification request message indicates an updated eco-rating score associated with the data session; and
reselecting, by the processor, a URSP rule from the list of URSP rules, wherein the reselected URSP rule comprises one or more descriptors matching the one or more eco-friendly requirements.

9. An apparatus, comprising:
a transceiver which, during operation, wirelessly communicates with a wireless network; and
a processor communicatively coupled to the transceiver such that, during operation, the processor performs operations comprising:
receiving information of an application associated with one or more eco-friendly requirements;
selecting a user equipment (UE) route selection policy (URSP) rule from a list of URSP rules, wherein the selected URSP rule comprises one or more descriptors matching the one or more eco-friendly requirements; and
determining a data session for routing traffic of the application between the apparatus and the wireless network based on one or more parameters included in a route selection descriptor (RSD) of the selected URSP rule.

10. The apparatus of claim 9, wherein the one or more descriptors are included in a traffic descriptor (TD) of the selected URSP rule, or included in the RSD of the selected URSP rule.

11. The apparatus of claim 9, wherein the one or more descriptors comprise at least one of the following:
an indication that a data network, a network slice, or a data session with a higher eco-rating score is preferred; and
a threshold corresponding to an eco-rating score above or equal to which a data network, a network slice, or a data session is preferred.

12. The apparatus of claim 11, wherein the eco-rating score indicates one of the following:
an energy efficiency level;
an energy consumption level;
a carbon intensity, carbon efficiency, carbon emission, or carbon footprint level; and
a renewable or clean energy level.

13. The apparatus of claim 9, wherein the data session is an existing data session that matches the RSD of the selected URSP rule.

14. The apparatus of claim 9, wherein, during operation, the processor further performs operations comprising:
transmitting, via the transceiver, a data session establishment request message to a network node of the wireless network based on the RSD of the selected URSP rule; and
receiving, via the transceiver, a data session establishment accept message from the network node, wherein the data session establishment accept message comprises information of the data session.

15. The apparatus of claim 14, wherein the data session establishment accept message comprises an eco-rating score associated with the data session, and the processor, during operation, further performs operations comprising:
determining whether to use the data session based on the eco-rating score in the data session establishment accept message.

16. The apparatus of claim 15, wherein, during operation, the processor further performs operations comprising:
receiving, via the transceiver, a data session modification request message from the network node, wherein the data session modification request message indicates an updated eco-rating score associated with the data session; and
reselecting a URSP rule from the list of URSP rules, wherein the reselected URSP rule comprises one or more descriptors matching the one or more eco-friendly requirements.

17. A method, comprising:
receiving, by a processor of a first network entity, network analytics related to eco-rating information from a second network entity;
adjusting, by the processor, a precedence of one or more route selection descriptors (RSDs) in a user equipment (UE) route selection policy (URSP) rule, wherein the RSDs comprise one or more relay service codes (RSCs) selected based on the eco-rating information; and
updating, by the processor, one or more parameters of the URSP rule.

18. The method of claim 17, further comprising:
subscribing, by the processor, to notifications of the network analytics related to eco-rating information from the second network entity.

19. The method of claim 17, wherein the one or more RSCs comprise at least one of the following:
a network slice;
a data network name;
a data session type;
a session and service continuity (SSC) mode; and
an access type.

20. The method of claim 17, wherein the eco-rating information comprises an eco-rating score indicating one of the following:
an energy efficiency level;
an energy consumption level;
a carbon intensity, carbon efficiency, carbon emission, or carbon footprint level; and
a renewable or clean energy level.
